(19) United States
(12) Patent Application Publication
(10) Pub. No.: US 2005/0274248 A1
(43) Pub. Date: Dec. 15, 2005

(54) Roll dispenser and cutter for large disposable bath towels

(75) Inventors: Bobby Frank Hicks, Midland, TX (US); Gary Smyrs, Midland, TX (US)

Correspondence Address: H. JAY SPIEGEL, P.O. Box 11, Mount Vernon, VA, 22121, US

(73) Assignee: CRYS-TOWEL, INC.

(21) Appl. No.: 10/864,357

(22) Filed: Jun. 10, 2004

(51) Int. Cl. B26D 5/08; B26D 7/00

(52) U.S. Cl. 83/614; 83/649; 83/937; 83/635

(57) ABSTRACT

A dispenser includes a housing having an internal chamber sized to rotatably receive a roll of absorbent paper. An elongated slot is provided through which an end of the roll of paper may protrude. Running along the length of the slot in the chamber is a pivoting mechanism that carries a cutting mechanism. A locking mechanism is provided, interacting between the housing and pivoting mechanism, that allows the pivoting mechanism to be locked in an orientation and configuration in which it clamps a portion of the paper roll in fixed position at the location of the slot. In the clamped position, the cutting mechanism may be moved across the paper towel in a direction perpendicular to its direction of unrolling to facilitate cutting a length of towel from the roll. A releasing mechanism is provided that permits the pivoting mechanism to be released from its locked configuration after a length of paper towel has been cut from the roll.

### BACKGROUND OF THE INVENTION

The present invention relates to a roll dispenser and cutter for large disposable bath towels. In the prior art, it is known to dispense towels from a roll using a dispenser mechanism. However, Applicants are unaware of any such device including all of the features and aspects of the present invention.

In assisted living facilities, one of the largest expenses involves laundering of towels for residents. The cost for use of water, heating the water, purchase and wear and tear on washing machines, purchase of detergent, and other incidental expenses is enormous and contributes a healthy percentage to the bottom line expenses of such a facility. If it were possible to save some or all of those expenses, assisted living facilities could be made more profitable and/or could provide their services for more reasonable fees.

Heretofore, Applicants are unaware of any product or device which contemplates dispensing a disposable towel large enough to dry a human being after taking a bath or shower. Such a device would facilitate the use of disposable paper products to dry the residents of an assisted care facility. Under such circumstances, the cost savings described hereinabove are achievable. It is with this thought in mind, and the use of such a device in analogous situations, that the present invention was developed.

The following prior art is known to Applicants:

| | |
|---|---|
| 585,291 to Sohlander | 1,940,976 to Simonton |
| 804,520 to Colthar | 1,967,516 to Ridgely |
| 821,681 to Vandermark | 2,263,311 to Ream |
| 940,364 to Rosebery | 3,452,511 to Hoffler |
| 1,202,435 to Scardino | 4,241,504 to Ceron |
| 1,798,250 to Galvin | 5,079,941 to De Blok et al. |

Sohlander and Colthar teach the combination of a roller-type cutter mounted on a support allowing the roller to be pivoted about a pivot having an axis perpendicular to the axis of rotation of the roller. The present invention differs from the teachings of these patents as contemplating mounting a roller-type cutter on a mechanism designed to hold the entire width of towel in place during the cutting operation.

Vandermark, Scardino, Galvin, Simonton, Ridgely, Ream and Ceron each teach the general concept of a roller-type cutter. While the present invention contemplates use of such a cutter, other types of cutting mechanisms are equally applicable to the broadest teachings of the present invention.

Rosebery, Hoffler and De Blok et al. teach the combination of a roll of paper or other material mounted on a dispenser combined with a cutting mechanism to cut a desired length of the paper or other material. The present invention differs from the teachings of these patents as contemplating particular structure which carries the cutting mechanism in such a manner that the structure can clamp about the paper throughout its length to best facilitate cutting a desired length of paper from the roll thereof.

### SUMMARY OF THE INVENTION

The present invention relates to a roll dispenser and cutter for large disposable bath towels. The present invention includes the following interrelated objects, aspects and features:

(1) In a first aspect, the present invention contemplates a dispenser that may be mounted on a wall or other vertical surface. The dispenser includes a housing having an internal chamber sized to rotatably receive a roll of absorbent paper.

(2) The housing has an elongated slot through which an end of the roll of paper may protrude. The roll is rotatably mounted in the housing through the provision of opposed ends of the chamber having internally protruding posts that capture open lateral sides of the roll of paper. If desired, one end of the housing may be removable to facilitate installation of the roll of absorbent paper in a manner that will be described in greater detail hereinafter.

(3) Running along the length of the slot in the chamber is a pivoting mechanism that carries a cutting mechanism. In one example, the cutting mechanism may consist of a roller-type cutter that is slidably mounted on the pivoting mechanism so that it may slide across the slot, in a manner to be explained in greater detail hereinafter, to cut off a desired length of towel from the roll.

(4) A locking mechanism is provided, interacting between the housing and pivoting mechanism, that allows the pivoting mechanism to be locked in an orientation and configuration in which it clamps a portion of the paper roll in fixed position at the location of the slot. In the clamped position, the cutting mechanism may be moved across the paper towel in a direction perpendicular to its direction of unrolling to facilitate cutting a length of towel from the roll.

(5) In an important aspect of the present invention, a releasing mechanism is provided that permits the pivoting mechanism to be released from its locked configuration after a length of paper towel has been cut from the roll. In this regard, release levers are positioned at each end of the pivoting mechanism, and in a position where they may be engaged by the body of the cutting mechanism. Thus, when the cutting mechanism has completed cutting a length of paper towel from the roll thereof, the body of the cutting mechanism may engage one of the release levers to release the locking mechanism, thereby permitting the pivoting mechanism to open to facilitate pulling the next length of towel from the roll.

As such, it is a first object of the present invention to provide a roll dispenser and cutter for large disposable bath towels.

It is a further object of the present invention to provide such a device in which a large roll of absorbent paper is releasably mounted within the chamber of a housing having a lateral exit slot.

It is a still further object of the present invention to provide such a device in which a cutting mechanism is mounted on a pivotable mechanism or support so that the cutting mechanism can be moved into and out of a cutting position.

It is a still further object of the present invention to provide such a device in which, in one preferred embodiment thereof, the cutting mechanism consists of a roller-type cutter.

It is a still further object of the present invention to provide such a device in which a locking mechanism is provided to allow locking of the pivoting mechanism in an orientation during which the cutting mechanism is operated.

It is a still further object of the present invention to provide such a device in which a releasing mechanism is provided between the pivoting mechanism and the housing which facilitates release of the pivoting mechanism from its locked orientation once a piece of absorbent paper is cut from the roll thereof.

These and other objects, aspects and features of the present invention will be better understood from the following detailed description of the preferred embodiments when read in conjunction with the appended drawing figures.

### BRIEF DESCRIPTION OF THE DRAWINGS

FIG. 1 shows a front view of the present invention with the pivoting mechanism locked in the closed position.

FIG. 2 shows a further front view of the present invention with the cutting mechanism moved to a position releasing the locking mechanism.

FIG. 3 shows an enlarged perspective view of the present invention with the pivoting mechanism in the open position.

FIG. 4 shows a side view of the present invention with the pivoting mechanism in the closed position, corresponding to the position shown in FIG. 1.

FIG. 5 shows a further side view of the present invention with the pivoting mechanism in the open position, corresponding to FIG. 3.

FIG. 6 shows an enlarged partial front view of the present invention, corresponding to FIG. 1.

FIG. 7 shows a cross-sectional view along the line 7-7 of FIG. 6.

FIG. 8 shows a front view of the present invention from a similar orientation as shown in FIG. 2, but with portions removed to enhance understanding.

FIG. 9 shows a schematic representation of the relationship between the cutting mechanism and the releasing mechanism in a first position thereof.

FIG. 10 shows a schematic representation of the relationship between the cutting mechanism and the releasing mechanism in a second position thereof.

FIG. 11 shows an enlarged rear view of the present invention showing the position of the cutting mechanism just before it engages the releasing mechanism.

### SPECIFIC DESCRIPTION OF THE PREFERRED EMBODIMENTS

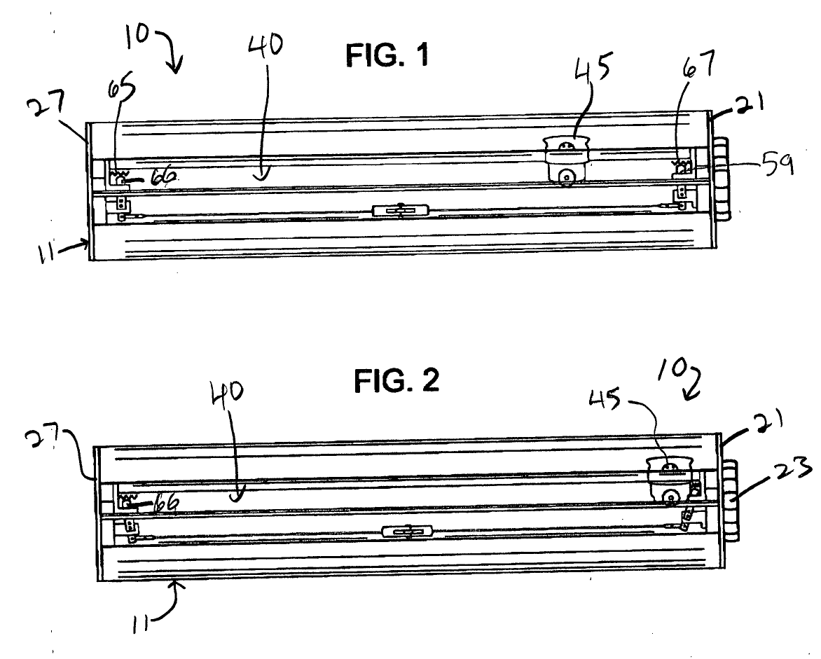

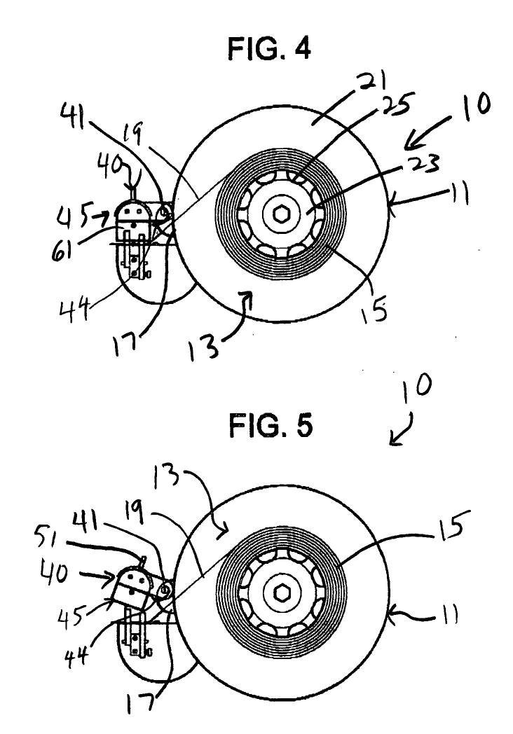

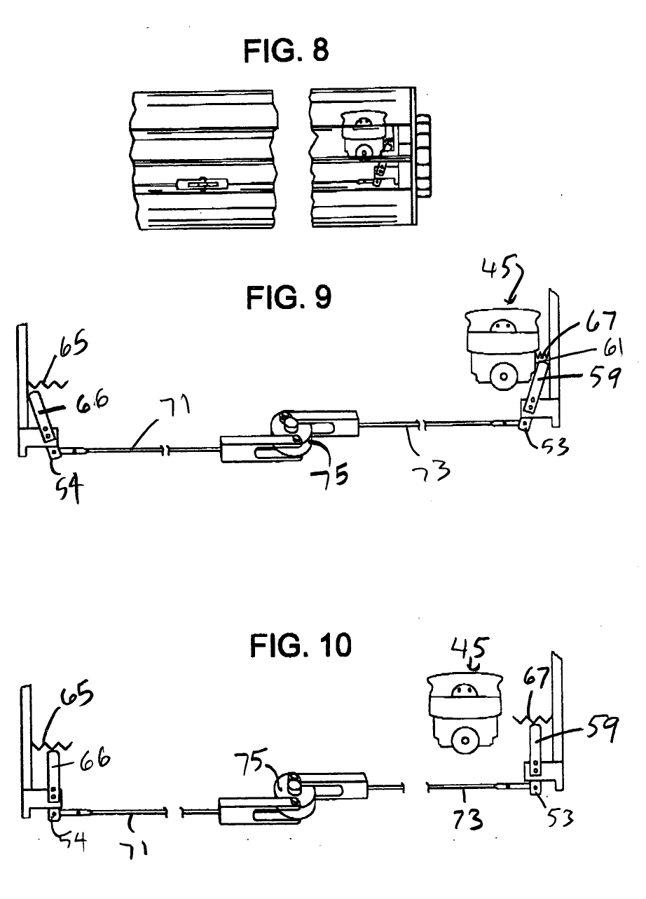

With reference to FIGS. 1-11, the present invention is generally designated by the reference numeral 10 and is seen to include a housing 11 defining an internal chamber 13 (FIGS. 4 and 5) sized and configured to receive a roll 15 of a flexible web of material such as, for example, absorbent paper.

With particular reference to FIGS. 4 and 5, the housing 11 includes a slot 17 that allows the web 19 of absorbent paper to be unrolled out of the chamber 13.

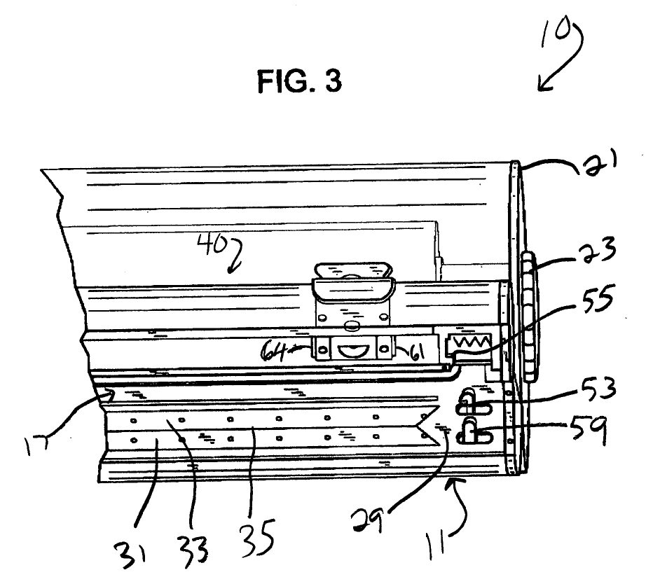

In one example of the preferred embodiment of the present invention, the housing has an end wall 21 (FIG. 3) that is removable to allow access to the chamber 13 to allow installation of the roll 15. For this purpose, a disk-like member 23 (FIGS. 3-5) is fixedly mounted on the wall 21 and includes a scalloped periphery 25 permitting the user to grip the disk 23 and pull the wall 21 from its installation on the housing 11. If desired, the wall 21 may have an inwardly facing projection (not shown) that may slightly enter from the side into a core (not shown) on which the web 19 is wound. The wall 27 (FIGS. 1 and 2), opposite the wall 21, may have a similar inwardly facing projection (not shown).

With reference to FIG. 3, adjacent the slot 17, a flat surface 29 is provided on the housing 11 which may have mounted thereon elongated metal strips 31 and 33 defining therebetween a slight gap 35 (FIG. 3). This gap 35 is provided for a purpose to be described in greater detail hereinafter.

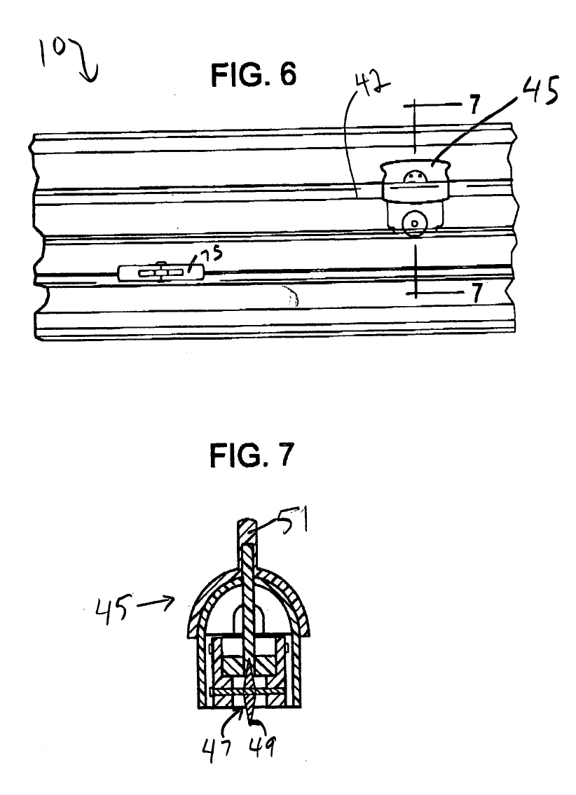

With reference, now, to FIGS. 3-5 and 7, a pivoting member or mechanism 40 is mounted to the housing 11 by virtue of pivots 41, one of which is shown in FIGS. 4 and 5, in particular. As should be understood from the figures, the pivoting member or mechanism 40 extends the length of the slot 17 as do the strips 33 and 35. With further reference to FIGS. 3-5 and 7, in particular, a cutting mechanism 45 is carried by the pivoting member. The cutting mechanism 45 is mounted in a manner well known to those of ordinary skill in the art in a slot 42 (FIG. 6) permitting it to slide from one lateral extent of the pivoting member 40 to another. With reference to FIGS. 1 and 2, the cutting mechanism 45 is seen in two different positions along the width of the pivoting member 40.

With reference to FIG. 7, in one preferred embodiment of the cutting mechanism, the cutting member consists of a wheel 47 having a sharp pointed periphery 49. When the pivoting member 40 has been pivoted to the position shown in FIG. 4, the sharp edge 49 of the wheel 47 is aligned with the groove 35 between the strips 31 and 33 (FIG. 3).

The cutting mechanism 45 is movable along the width of the pivoting member 40 along the slot 42 (FIG. 6) by gripping the hand grip 51 (FIGS. 5 and 7) and physically moving it from one end to the other, while the edge 49 of the wheel 47 rolls over the groove 35.

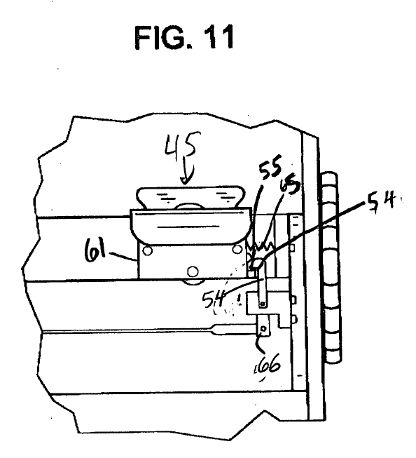

With reference to FIGS. 4 and 5, the pivot 41 for the pivoting member 40 includes a coil spring 44 that tends to bias the pivoting member 40 in the direction of its open orientation seen in FIG. 5. The position shown in FIG. 4 is retained by virtue of latches that engage hooks on either end of the pivoting member. In this regard, with reference to FIG. 3, a hooked latch or hook 53 is configured to engage a shoulder 55 on the pivoting member 40 when the pivoting member 40 is in the closed position. This is seen with reference to FIG. 11 which depicts the hook 54 at the opposite end of the pivoting member 40 engaging the shoulder 55 at that end.

With reference back to FIG. 3, an actuating lever 59 is coupled to the hooked latch or hook 53 and these two devices are constrained to pivot together. Thus, looking at FIGS. 3 and 11, in the position shown in FIG. 11 with the pivoting member 40 in the closed locked configuration, pivoting of the actuating lever 59 to the right in the view of FIG. 3 causes the latch 53 to move to the right to uncouple it from the shoulder 55 on the pivoting member 40. When this occurs, the coil spring biasing means 44 mounted in the pivot 41 causes the pivoting member 40 to pivot to the position shown in FIG. 5 from the locked position shown in FIG. 4. As should be understood, the cutting mechanism 45 is shown in FIG. 11 from the rear and, as such, is at the opposite end of the housing 11 from its location shown in FIG. 3. This is done for clarity of explanation of operation.

With reference to FIGS. 4 and 5, the cutting mechanism 45 has a side wall 61 (FIGS. 3 and 4) that is adapted to engage the actuating lever 59 when the cutting mechanism 45 is extended in its most extreme right-hand location (FIG. 2) causing the lever 59 and the latch 53 to pivot and thereby release the pivoting member 40 so that it moves under the force of the coil spring 44 to the position shown in FIG. 5. The extreme right-hand position of the cutting mechanism 45 is best seen with reference to FIG. 2, and FIG. 2 shows the pivoted position of the lever 59 and latch 53. The cutting mechanism has a corresponding wall 64 that performs the same function at the opposite end of the pivoting member or mechanism 40. See FIG. 11.

With further reference to FIGS. 1 and 2, it is seen that a mirror image lever 66 and latch 56 are also located on the left-hand side of the pivoting member 40. Springs 65 and 67 (FIGS. 1, 9, 10 and 11) ensure that the cutting mechanism 45 does not remain in a position causing pivoting of the lever 59 or 66 when such motion is not desired. The levers 59 and 66 are coupled together and constrained through their coupling mechanism to move simultaneously in opposite directions.

In this regard, particular reference is now made to FIGS. 9 and 10 which show that the levers 66 and 59 are coupled together via rods 71, 73 having first ends coupled to the latches 53 and 54 which, as explained above, are constrained to move with the levers 59 and 66. The other ends of the rods 71 and 73 are coupled to diametrically opposite sides of a disk 75 as best seen in FIGS. 9 and 10. Thus, comparing FIGS. 9 and 10, when the lever 59 pivots in the clockwise direction in the view of FIG. 10, for example, the lever 66 pivots in the counterclockwise direction in the same view, and vice-versa. The levers 59 and 66 are biased in a manner well known to those skilled in the art to the position shown in FIG. 10 in which the respective latches 53 and 54 would engage the shoulders such as the shoulder 55 shown in FIG. 11 to hold the pivoting member 40 in the position shown in FIG. 4.

Now, with reference to the figures, the preferred manner of operation of the present invention will now be described.

With a roll 15 contained within the chamber 13, the web 19 is extended through the elongated opening 17 (FIG. 5) until a desired length has been pulled through the opening 17. At that point, the pivoting member 40 is pivoted to the position shown in FIG. 4, whereupon the latches 53, 54 engage the shoulders 55 at opposite ends of the pivoting member 40 to hold it in the position shown in FIG. 4, for example. In that position, a portion of the web 19 is clamped between the structure of the pivoting member 40 and the strips 31 and 33 shown in FIG. 3. In that configuration, the cutting mechanism 45 is moved from one end of the pivoting member 40 to the other end thereof with the sharp edge 49 (FIG. 7) of the cutting wheel 47 pressing against the groove 35 (FIG. 3) between the metal strips 31 and 33. In this manner, the web 19 is cut at the location of the groove 35 and the portion of the web extending beyond the groove 35 outside the housing 11 may suitably be removed.

As should be understood with reference to FIGS. 1-3 and 9-10, in particular, when the wall 61 of the cutting mechanism 45 hits the lever 59 (FIG. 9), this causes the lever 59 to pivot to the position shown in FIG. 9 and the latch 53 to pivot correspondingly to release the latch 53 from the shoulder 55 as shown in FIG. 3, whereupon the spring 44 biasing the pivoting member 40 in the direction of the orientation shown in FIG. 5 causes the pivoting member 40 to move to that position. In the meantime, as the pivoting member 40 is moving to the position shown in FIG. 5, the spring 67 (FIG. 10) pushes the cutting mechanism 45 away from the right-hand extremity of the housing so that if the pivoting member 40 is moved to the position shown in FIG. 4, the cutting mechanism 45 will not be engaging the lever 59, such that the latch 53 may move to the position shown in FIG. 10 engaging the shoulder 55 (FIG. 3) to hold the pivoting member 40 in the position best seen in FIG. 4. The device operates in an analogous manner if the cutting mechanism 45 is moved in the left-hand direction in the view of FIGS. 1 and 2 to cut the web 19 in that direction. This is best understood from FIGS. 1-2 and 9-10.

As such, an invention has been disclosed in terms of preferred embodiments thereof which fulfill each and every one of the objects of the invention as set forth hereinabove, and provide a new and useful roll dispenser and cutter for large disposable bath towels of great novelty and utility.

Of course, various changes, modifications and alterations in the teachings of the present invention may be contemplated by those skilled in the art without departing from the intended spirit and scope thereof.

As such, it is intended that the present invention only be limited by the terms of the appended claims.

1. A dispenser for a rolled web, comprising:
a) a housing having an internal chamber and a laterally extending slot accessing the chamber;
b) a roll removably disposed within said chamber comprising a web of material having an end extendable through said slot;
c) a pivoting mechanism adjacent said slot and pivotable between a first position exposing said slot, and a second position covering said slot;
d) a cutting mechanism carried by said pivoting mechanism, and movable laterally across an extent of said slot;
e) a locking mechanism adapted to releasably retain said pivoting mechanism in said second position; and
f) a releasing mechanism adapted to release said locking mechanism to permit said pivoting mechanism to move to said first position.

2. The dispenser of claim 1, wherein said roll comprises a roll of absorbent paper.

3. The dispenser of claim 2, wherein said housing includes a side wall removable from said housing to facilitate installation of said roll.

4. The dispenser of claim 1, wherein said pivoting mechanism is biased in a direction of movement toward said first position.

5. The dispenser of claim 4, wherein said pivoting mechanism is biased toward said first position by a coil spring.

6. The dispenser of claim 1, wherein said cutting mechanism comprises a wheel having a sharp peripheral edge.

7. The dispenser of claim 6, wherein said housing includes a flat surface with an elongated groove defined thereon, said peripheral edge of said wheel being aligned with said groove in the second position of said pivoting mechanism.

8. The dispenser of claim 7, wherein said groove is defined between two elongated strips on said flat surface of said housing.

9. The dispenser of claim 8, wherein said strips are made of metal.

10. The dispenser of claim 1, wherein said locking mechanism comprises a pivotable hook on said housing movable between a first orientation engaging a shoulder on said pivoting mechanism, and a second orientation spaced from said shoulder.

11. The dispenser of claim 10, wherein said releasing mechanism includes an actuating lever constrained to move with said hook.

12. The dispenser of claim 11, wherein said cutting mechanism includes a side surface engageable with said lever when said cutting mechanism is moved to an end of said slot to move said lever and release said hook.

13. The dispenser of claim 12, further including a spring adjacent said lever and adapted to engage said side surface of said cutting mechanism to move said cutting mechanism away from said lever after said lever has been actuated to release said hook.

14. The dispenser of claim 13, wherein said pivotable hook comprises a first pivotable hook located at one end of said slot, and further including a second pivotable hook on said housing located at another end of said slot.

15. The dispenser of claim 14, wherein said actuating lever comprises a first actuating lever located at said one end of said slot, and further including a second actuating lever located at said another end of said slot.

16. The dispenser of claim 15, wherein said actuating levers are constrained to move together in opposite directions by a linkage therebetween.

17. The dispenser of claim 16, wherein said linkage comprises a disk and two rods mounted to said disk at diametrically opposed positions thereon, respective ends of said rods distal from said disk attached to respective ones of said levers.
